(19) United States
(12) Patent Application Publication
(10) Pub. No.: US 2015/0339672 A1
(43) Pub. Date: Nov. 26, 2015

(54) AUTOMATION TOOL DEVELOPMENT METHOD FOR BUILDING COMPUTER FRAUD MANAGEMENT APPLICATIONS

(71) Applicant: Brighterion, Inc., San Francisco, CA (US)

(72) Inventor: Akli Adjaoute, Mill Valley, CA (US)

(73) Assignee: BRIGHTERION, INC., San Francisco, CA (US)

(21) Appl. No.: 14/815,848

(22) Filed: Jul. 31, 2015

Related U.S. Application Data
(63) Continuation-in-part of application No. 14/514,381, filed on Oct. 15, 2014.
Application No. 14/514,381 is a continuation-in-part of application No. 14/454,749, filed on Aug. 8, 2014.

(51) Int. Cl. G06Q 20/40; G06N 5/04; G06N 99/00

(52) U.S. Cl. CPC G06Q 20/4016; G06N 99/005; G06N 5/04

(57) ABSTRACT

A method of fraud management follows several steps that each require the involvement and support of financial networks, secure servers, and proprietary databases. A selected variety of fraud classification algorithms are assembled together into a “jury” that includes neural networks, case based reasoning, decision trees, genetic algorithms, fuzzy logic, and rules and constraints. Operating parameters that matter specifically to each are extracted in parallel from the same records of historical transaction data, and that then is used to initialize a general payment fraud model. This is then converted into computer-program executable form for later execution on a third party computer system. These are further integrated by expert programmers and development system with smart agents and associated real-time profiling, recursive profiles, and long-term profiles. The trainable general payment fraud product is applied by a payments-processing client to screen real-time transactions and authorization requests for fraud.

### BACKGROUND OF THE INVENTION

1. Field of the Invention

The present invention relates to automation tools for the application development of fraud management systems, and more particularly to multi-discipline artificial intelligence machines for real-time use on big data.

2. Background

A multi-disciplinary approach to problem solving is sometimes the best. We've done it for centuries with panels of juries who are charged with finding the “truth” from the evidence presented to them in court. Each juror hears and sees the same evidence, but each juror brings a different skill set, education, maturity, experience, and disposition to the questions before them. And so it's very common for not all the jurors to agree on a verdict.

So too with artificial intelligence (AI) fraud classification models and algorithms that try to sort and classify fraudulent transactions from the streams of millions of payment authorization requests flowing into financial networks and their secure payment authorization servers. Conventional methods vary, and so too do their success rates at finding fraud. And fraud is adaptive, like a natural virus, it will exploit and adjust to changing environments and defenses. So good defenses need to change and adapt as well.

e-commerce is growing at an extraordinary pace and, as a consequence, so is Card-Not-Present (CNP) fraud. Address Verification System (AVS), CVV2, and other first generation tools used in the past caused high amounts of “friction” with users. Customer input errors made for a higher error rates, and declines in orders were assumed to be fraud. Good solutions that identify legitimate cardholder transactions and still provide a friction-less customer experience while maintaining security are everyone's goals.

Even with the impressive recent developments in Information Technology and in our communication channels, fraud is nevertheless spreading all over the world, resulting in ever-increasing financial losses. Chip-and-PIN fraud prevention mechanisms cannot prevent fraudulent mail order and virtual point-of-sale (POS) terminal payment card transactions. Detecting the fraud indirectly seems about the only way to stop fraud in these channels.

Classification models based on decision trees, neural networks, and support vector machines (SVM) have been developed and long been applied to the credit card fraud detection problem, as have many other discrete ways. Each have shown some weaknesses, and each have shown some strengths. But no single one seems to be a universal method.

What is needed is “broad spectrum medicine” to cure, or at least control, the infestations of fraud appearing everywhere in our financial systems.

### SUMMARY OF THE INVENTION

Briefly, a method of fraud management in an embodiment of the present invention comprises several steps that require the involvement and support of financial networks, secure servers, and proprietary databases. A selected variety of fraud classification algorithms are assembled together into a “jury” that includes neural networks, case based reasoning, decision trees, genetic algorithms, fuzzy logic, and rules and constraints. Operating parameters that matter specifically to each are extracted in parallel from the same records of historical transaction data, and that then is used to initialize a general payment fraud model. This is then converted into computer-program executable form for later execution on a third party computer system. These are further integrated by expert programmers and development system with smart agents and associated real-time profiling, recursive profiles, and long-term profiles. The trainable general payment fraud models are trained with supervised and unsupervised data to produce an applied payment fraud model. This commercial product is applied by a payments-processing client to screen real-time transactions and authorization requests for fraud.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a flowchart diagram of a method embodiment of the present invention that depends on the use of data processing systems and networks as represented in FIG. 2;

FIG. 2 is a function block diagram of the kinds of computers networks and data processing equipment needed to perform each step of the methods of FIGS. 1 and 3; and

FIG. 3 is flowchart diagram of a three-phase method embodiment of the present invention that includes development, customization-preparation, and application.

### DETAILED DESCRIPTION OF THE INVENTION

This application is a continuation-in-part of U.S. patent application Ser. No. 14/514,381, filed Oct. 15, 2014, and published as US 2015-0032589 A1. Such is incorporated herein, in full, by reference. An artificial intelligence fraud management method id described that comprises an expert programmer development system for building trainable general payment fraud models that integrate several, but otherwise blank artificial intelligence classifiers, e.g., neural networks, case based reasoning, decision trees, genetic algorithms, fuzzy logic, and rules and constraints. These are further integrated by the expert human programmers' inputs and development system to include smart agents and associated real-time profiling, recursive profiles, and long-term profiles.

Trainable general payment fraud models are produced that can trained with highly filtered supervised and unsupervised data to produce a very specialized and targeted payment fraud model. For example, accountholder and historical transaction data for card-not-present channels. These trained payment fraud models can then be inventoried and sold as a sort of computer program library or a software-as-a-service applied payment fraud model. This then is custom applied by a particular commercial client in an applied payment fraud model to process their particular brand real-time transactions and authorization requests for fraud scores according to their rules and predilections. The applied payment fraud model is further able to accept ongoing client-tuning inputs.

An application development system (ADS) comprises a number of computer program development libraries and tools that highly skilled artificial intelligence scientists and artisans can manipulate into a novel combination of complementary technologies. In an early embodiment of ADS we combined a goal-oriented multi-agent technology for building run-time smart agents, a constraint-based programming tool, a fuzzy logic tool, a library of genetic algorithms, a simulation and planning tool, a library of business rules and constraints, case-based reasoning and learning tools, a real-time interpreted language compiler, a C++ code generator, a library of data compression algorithms, and a database connectivity tool.

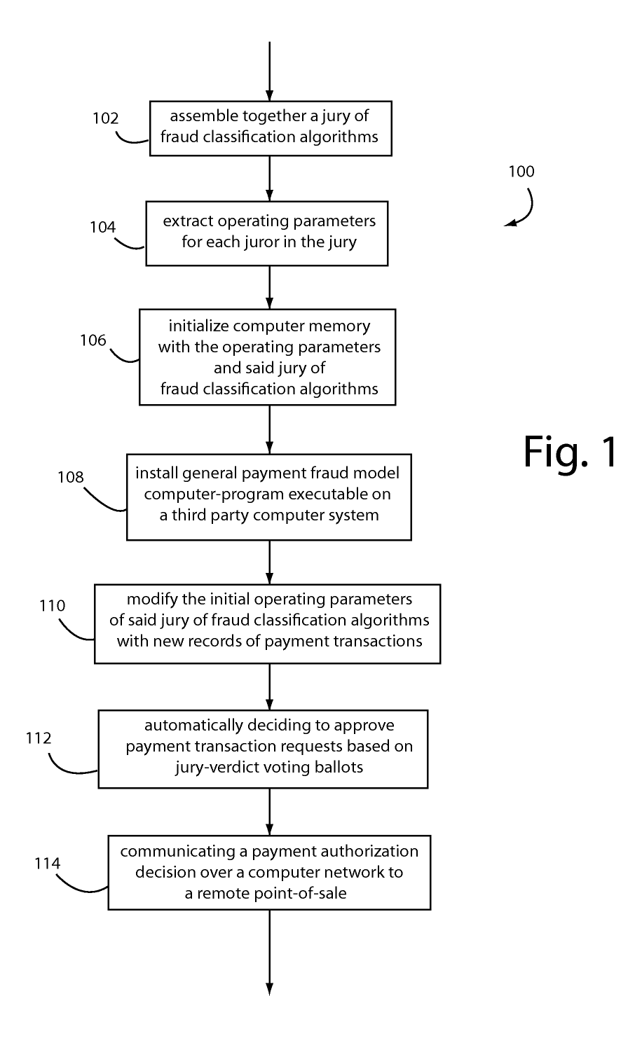

Here, FIG. 1 represents a method 100 of automation tool development for building general computer fraud management applications for third party computers.

A step 102 uses a computer development system to assemble together what constitutes a “jury” of “jurors” that will all receive the same payment transaction information data from a network at the same time. But each such juror will come to their own conclusions and fraud classifications, respectively, according to their unique artificial intelligence (AI) talents, skills, experience, and abilities to learn. Not unlike how human juries function in courtrooms, but here at millions of “verdicts” per second.

Each such AI juror resembles in computer data processing terms, a traditional classification technology in algorithm form, and includes decision trees, case-based reasoning, neural networks, genetic algorithms, etc. These jurors are joined by a very special juror, the present inventor's own unique “smart agent” AI algorithms that spawn and assign an individual smart agent to every actor, entity, or thing discernible from data mining the incoming payment transaction records. These smart agents essentially track, follow, and profile the short-term, long-term, and recursive payment-transaction behaviors of each actor, entity, or thing for in the data mining, and develop a computed statistic on an abstract of the mean behavior. New behaviors can be matched to these as templates to discern instances of out-of-character behavior, and probable fraud. “False positives” occur when the automation gets it wrong, e.g., a legitimate transaction is blocked as being fraudulent.

A step 104 uses a computer especially programmed to extract, in parallel, initial sets of operating parameters from the same historical records of payment transactions for each juror in a jury of fraud classification algorithms.

A step 106 initializes addresses in a non-volatile programmable computer memory with several of the initial sets of operating parameters, together with corresponding computer implementations of the jury of fraud classification algorithms, to produce a commercially deliverable and trainable general payment fraud model computer-program executable that is then operable on a third party computer system.

A step 108 installs the general payment fraud model computer-program executable onto a third party computer system.

A step 110 modifies the memory programming of the initial sets of operating parameters with data obtained from records of payment transactions processed for payment authorization requests received by the third party computer system.

A step 112 automatically decides with a classification algorithm whether to approve individual payment authorization requests received by the third party computer system based on a jury-verdict ballot by each of the jury of fraud classification algorithms operating within and each respectively using modified sets of the initial operating parameters.

And a step 114 communicates a payment authorization decision encoded in a data packet over a computer network to a remote point-of-sale.

Incremental learning technologies are embedded in the machine algorithms and smart-agent technology to continually re-train from any false positives and negatives that occur along the way. Each corrects itself to avoid repeating the same classification errors. Data mining logic incrementally changes the decision trees by creating a new link or updating the existing links and weights. Neural networks update the weight matrix, and case based reasoning logic updates generic cases or creates new ones. Smart-agents update their profiles by adjusting the normal/abnormal thresholds, or by creating exceptions.

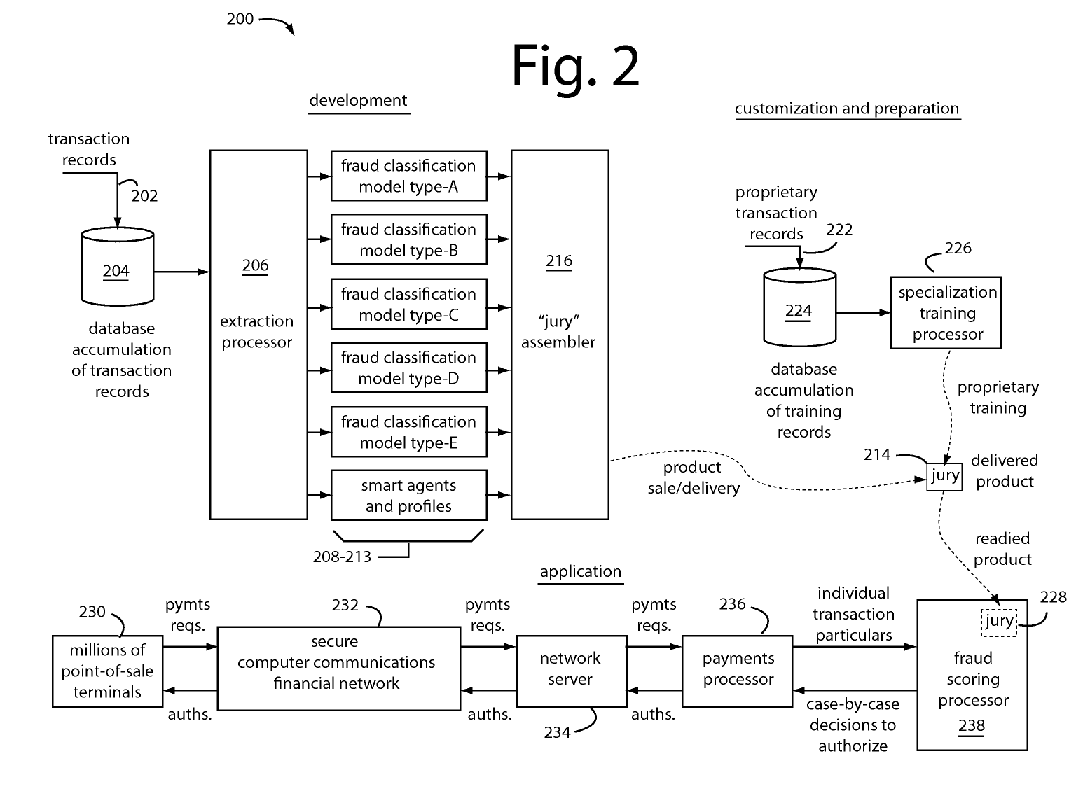

FIG. 2 illustrates an example of the computer and network machinery 200 required to implement the Method of FIG. 1. There are three phases of development, customization/preparation, and application involved that occur one after the other and in that order. In the development phase, historical transaction records 202 of a plurality of financial institutions are “poured” into a database 204 that accumulates and stores these records. A computer and operator console 206 are programmed to extract fraud classification parameters for several different classification algorithms 208-213 in parallel from the same collection points provided by database 204.

These classification algorithms 208-213 and their respective fraud classification parameters are bound together into a general purpose “jury” device 214 by a computer program compiler, jury assembler 216.

Jury device 214 is a transportable computer program record that is embodied on a disk, a tape, a file, a data packet, etc. It is also the tangible thing that can be advertised, marketed, sold, delivered, and installed on a third party computer data processing system.

A second phase, customization and preparation, occurs at a secure end user location. There, a proprietary transaction record file 220 is used to build an accumulation of training records in a database 222. A specialization training processor 224 in a data processing system fine-tunes the parameters embedded in jury device 214 according to the end users' own experiences and preferences. A fully operational and ready-to-use jury device 228 is then used in the third phase.

A third phase is the application and real-time use. In a conventional financial payment system that allows shoppers to use credit cards, debit cards, and other payment cards, millions of point-of-sale (POS) terminals 230 collect card-present and card-not-present account information and make payment requests in secure messages carried in data packets over computer networks. For example, a secure computer communications financial network 232. These payment requests are all forwarded by a network server 234 to a payments processor 236. The individual transaction particulars are sent by network data packets to a fraud scoring processor 238. Such is expected to return a payment authorization quickly, within milliseconds back to POS 230. A credit card issuer and payments processing business is highly dependent on how well a job is done by the fraud scoring processor 238.

The method of FIG. 1 and the computer hardware used to produce ready-to-use jury device 228 will improve business profits by reducing losses due to fraud, transactions that should have been denied, and lost revenues, sales losses due to transactions that were denied but were in fact legitimate or advantageous.

The ready-to-use jury device 228 is therefore installed in the end users' applications and run daily to manage payment fraud.

In general, embodiments of the present invention deliver an automation tool for the application development of multi-discipline artificial intelligence fraud management systems. An expert programmer development system with tools and software libraries is used for building trainable general payment fraud models that are constructed of and integrate several artificial intelligence classifiers, including smart agents, neural networks, case-based reasoning, decision trees, and business rules. The trainable general payment fraud models are capable of being trained with historical transaction data that causes an initial population of smart agents and associated profiles to be generated, and an initial set of neural networks to assume a beginning weight matrix, and an initial decision tree to be structured from data mining logic, and an initial case-based reasoning set to be structured, and an initial set of business rules to be fixed. These trainable general payment fraud models are detachable and deliverable to third parties once built.

An incremental learning technology is embedded in a run-time machine algorithm and smart-agent technology that is able to continually re-train the artificial intelligence classifiers using feedback, e.g., false positives and negatives that occur during use.

Data mining logic is leveraged to incrementally change the initial decision trees by creating new links or updating their existing links and weights. Feedback also is helpful for the initial neural networks to have their weight matrices updated, and for the initial case-based reasoning logic to update its generic cases or to create new ones. The initial population of smart-agents are enabled to self-update their profiles and to adjust their normal/abnormal thresholds or by creating exceptions.

The unique and novel technology of the present inventor, Dr. Akli Adjaoute, and his Company, Brighterion, Incorporated (San Francisco, Calif.), is to integrate several different traditional classification algorithms into a “jury” in which each “juror” hears the same evidence but arrives at their respective verdicts from their unique perspectives. A majority vote would be one way to reach a “verdict”, but here the respective qualifications of the individual jurors can be analyzed and weighed into a final verdict of “payment fraud” or no fraud. The verdict determines whether the payment request is approved or declined.

Our methods involve a series of acts for protecting a computer from an electronic communication containing malicious code. The invention relates to software technology for isolation and extraction of malicious code contained in an electronic communication. Embodiments are directed towards physically isolating a received communication on a memory sector and extracting malicious code from that communication to create a sanitized communication in a new data file. The present invention is directed towards performing isolation and eradication of computer viruses, worms, and other malicious code, a concept inextricably tied to computer technology and distinct from the types of concepts found by the courts to be abstract.

The operational outputs of an expert programmer development system are trainable general payment fraud models, aka software on storage devices to run on specially designed and configured financial payment networks as applied payment fraud models.

A “programmer development system” is well understood by artisans to be a specialized computer system used as a tool by software programmers to build and test computer programs. Ours goes beyond that to require experts in classification algorithms to use such tool to mix and balance several different kinds of classification engines. These expert programmers provide graphic inputs that guide the programmer development system.

The application development system is used in “compile time” during preparation and testing of the trainable general payment fraud models. Such trainable general payment fraud models are delivered after development as a standard product to customers as software to train and otherwise customize to run on their computer systems during “run time”. Such application development system use as a tool is highly familiar to development programmers.

The “tools” referred to are in fact tools used by programmers to build more complex software modules without having to be expert on the functions and concepts behind each tool. Nowadays, these tools are embodied as libraries of C++ code.

Embodiments of the present invention highly leverage the use of an improved smart-agent technology building run-time smart agents that are essentially silhouettes of their constituent attributes. These attributes are themselves smart-agents with second level attributes and values that are able to “call” on real-time profilers, recursive profilers, and long term profilers.” At the top level of a hierarchy of smart agents linked by their attributes are the smart agents for the independent actors who can engage in fraud. In a payment fraud model, that top level will be the cardholders as tracked by the cardholder account numbers reported in transaction data. During a session in which the time-stamped relevant transaction data flows in, a set of classification algorithms operate independently according to their respective natures. A population of smart agents and profilers also operate on the time-stamped relevant transaction data inflows. Each new line of time-stamped relevant transaction data will trigger an update of the respective profilers. Their attributes are provided to the population of smart agents.

Embodiments of the present invention combine a broad variety of carefully selected and balanced classification algorithms. The classification algorithms and a population of smart agents and profilers all each produce an independent and separate jury vote on the same line of time-stamped relevant transaction data. A weighted summation processor, like a courtroom judge, receives the jury verdict. It further listens to client tunings to then output a final fraud judgment.

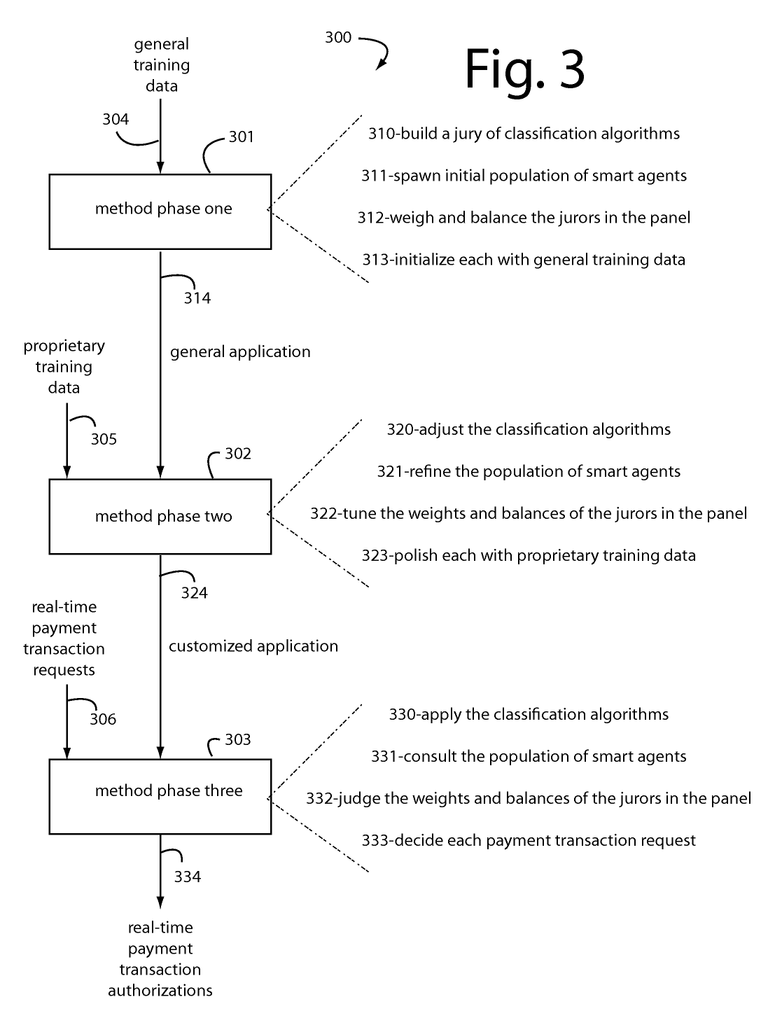

FIG. 3 represents a method payment card fraud management 300 that requires the use of data processing systems and networks like that illustrated in FIG. 2. Method 300 requires three phases 301-303: (1) the steps necessary to produce the computer programs needed to perform the remaining steps two and three, (2) the steps necessary to produce the computer programs needed to perform remaining step three, and (3) the steps needed to accept real-time payment transaction requests and respond with payment transaction authorizations. In one sense method 300 is a bootstrap.

Phase 301 requires the input of general training data 304 in the form of records of past transactions for this kind of financial channel, e.g., card-not-present transactions. Phase 302 requires the input of proprietary training data 305 in the form of supervised records of past transactions for this particular payments processor, e.g., MasterCard, VISA, Target, etc. Phase 303 requires the input of real-time payment authorization requests 306 in the form of data packets encoding such over a secure financial network from point-of-sale terminals and similar.

Phase 301 includes steps 310-313 to build a jury of classification algorithms, spawn initial population of smart agents, weigh and balance the jurors in the panel, and initialize each with general training data. A product, general application 314, is needed by the data processing systems and computer networks to perform the steps of phase two 302. The usual form of this product is a program execution file or core library.

Phase 302 includes steps 320-323 to adjust the classification algorithms, refine the population of smart agents, tune the weights and balances of the jurors in the panel, and polish each with proprietary training data. A product, customized application 324, is needed by the data processing systems and computer networks to perform the steps of phase three 303. The usual form of this product is a program execution file or core library.

Phase 303 includes steps 330-333 to apply the classification algorithms, consult the population of smart agents, judge the weights and balances of the jurors in the panel, and decide each payment transaction request. The results that are then producible by the data processing systems and computer networks are real-time payment transaction authorizations 334. The usual form of this result is an answer back encoded in data packets over a computer network to a point-of-sale (POS) terminal ready to complete a sales transaction.

The finer details of all this are to be found in the parent application, U.S. patent application Ser. No. 14/514,381, filed Oct. 15, 2014, and published as US 2015-0032589 A1, and is incorporated herein, in full, by reference.

Phase 301 (and steps 310-313 that build a jury of classification algorithms, spawn initial population of smart agents, weigh and balance the jurors in the panel, and initialize each with general training data) produces a program execution file or core library needed to support steps for:
(a) extracting initial sets of operating parameters from the historical records of payment transactions for each juror in a jury of fraud classification algorithms;
(b) initializing a programmable computer memory with several of the initial sets of operating parameters, together with corresponding computer implementations of said jury of fraud classification algorithms, to produce a commercially deliverable and trainable general payment fraud model computer-program executable that is then operable on a third party computer system;
(c) installing said general payment fraud model computer-program executable on a third party computer system;
(d) modifying the initial sets of operating parameters with data obtained from records of payment transactions processed for payment authorization requests received by the third party computer system;
(e) automatically deciding whether to approve individual payment authorization requests received by the third party computer system based on a jury-verdict ballot by each of said jury of fraud classification algorithms operating within and each respectively using modified sets of the initial operating parameters; and
(f) communicating a payment authorization decision over a computer network to a remote point-of-sale.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. A method payment card fraud management implemented on data processing systems and networks, comprising the following steps in a first phase that result in a general application:
inputting general training data in the form of records of past transactions for a particular kind of financial channel from a database;
building a jury of classification algorithms by calculating them with a computer programmed for this purpose;
spawning an initial population of smart agents with a computer programmed for this purpose that warehouses them in a data structure or record;
weighing and balancing the jurors in the jury panel with a computer programmed for this purpose that uses past experience to favor particular jurors with better than average levels of accuracy, and abstracts into in a data structure or record; and
initializing each juror with general training data with a computer programmed for this purpose, and abstracts into in a data structure or record; and
outputting a product, a general application, in the form of a program execution file or core library needed to be installed in a data processing system and computer network to perform any additional steps of this method.

2. The method of claim 1, implemented on data processing systems and networks, comprising the following steps in a second phase that result in a customized application:
inputting proprietary training data in the form of supervised records of past transactions for a particular kind of financial channel from a database;
adjusting the classification algorithms with a computer programmed for this purpose that warehouses them in a data structure or record;
refining the population of smart agents with a computer programmed for this purpose that warehouses them in a data structure or record;
tuning the weights and balances of the jurors in the panel with a computer programmed for this purpose that warehouses them in a data structure or record;
polishing each juror with proprietary training data with a computer programmed for this purpose that warehouses them in a data structure or record; and
outputting a product, a customized application, in the form of a program execution file or core library needed to be installed in a data processing system and computer network to perform any additional steps of this method.

3. The method of claim 2, implemented on a data processing system and network, comprising the following steps in a third phase that accepts real-time payment transaction requests and responds with payment transaction authorizations:
inputting payment authorization request records of real-time transactions over a network from point-of-sale terminals;
applying the classification algorithms with a computer programmed for this purpose that depends on data warehoused in said data structures or records;
consulting the population of smart agents with a computer programmed for this purpose that depends on data warehoused in said data structures or records;
judging the weights and balances of the jurors in the jury panel with a computer programmed for this purpose that depends on data warehoused in said data structures or records;
deciding each payment transaction request with a computer programmed for this purpose that depends on data warehoused in said data structures or records;
outputting payment transaction authorizations in an answer encoded in data packets back over a computer network to a point-of-sale (POS) terminal waiting for this to complete a sales transaction.

4. The method of claim 1, further comprising:
extracting initial sets of operating parameters from the historical records of payment transactions for each juror in a jury of fraud classification algorithms;
initializing a programmable computer memory with several of the initial sets of operating parameters, together with corresponding computer implementations of said jury of fraud classification algorithms, to produce a commercially deliverable and trainable general payment fraud model computer-program executable that is then operable on a third party computer system;
installing said general payment fraud model computer-program executable on a third party computer system;
modifying the initial sets of operating parameters with data obtained from records of payment transactions processed for payment authorization requests received by the third party computer system;
automatically deciding whether to approve individual payment authorization requests received by the third party computer system based on a jury-verdict ballot by each of said jury of fraud classification algorithms operating within and each respectively using modified sets of the initial operating parameters; and
communicating a payment authorization decision over a computer network to a remote point-of-sale.

5. The method of claim 1, further comprising:
requesting a payment authorization for a transaction from a remote point-of-sale computer terminal automatically through a computer network to a central payments processing server;
deciding whether to approve a particular request for payment authorization by use of said jury of fraud classification algorithms operating with modified sets of the initial operating parameters
communicating packet-switched data messages that include payment authorization requests over said computer network from said point-of-sale terminals to said central payments processing server;
approving or declining each said payment authorization request with a computer algorithm; and
communicating packet-switched data messages that include either an approved payment authorization message or a declined payment authorization message back over said computer network from said central payments processing server to a corresponding said point-of-sale terminal, the choice of which are dependent on said computer algorithm.

6. The method of claim 3, further comprising:
initializing a set of individual operating parameters of a mix of run-time smart agents, neural networks, case-based reasoning, decision trees, and business rules, with teachings obtainable from historical records of said payment authorization requests;
assembling said run-time smart agents, neural networks, case-based reasoning, decision trees, and business rules as jurors in a jury where each juror assesses in parallel the payment transaction risk presented to a financial institution for each payment authorization request arriving at said central payments processing server, and outputting a juror vote;
balancing and weighing the juror votes of respective said jurors with an algorithm executed by a computer into a decision to approve or a decision to decline an instant payment authorization request that is electronically encoded into a return message communicated over said computer network.

7. The method of claim 6, further comprising:
encapsulating the computer algorithm results and their initialized parameters from the step of assembling into a single trainable general payment fraud model computer-program executable that is then operable on a third party computer system.

8. The method of claim 7, further comprising:
training said trainable general payment fraud model executable with historical transaction data that structurally changes each of the constituents to produce fewer false positives;
identifying and then generating from said historical transaction data an initial population of smart agents and associated profiles and further integrated them into said trainable general payment fraud model executable;
generating an initial set of neural networks with a beginning weight matrix from said historical transaction data and further integrated them into said trainable general payment fraud model executable;
subsequently structuring from said historical transaction data an initial decision tree from data mining logic and further integrated them into said trainable general payment fraud model executable;
subsequently structuring from said historical transaction data an initial case-based reasoning set and further integrated them into said trainable general payment fraud model executable;
subsequently fixing from said historical transaction data an initial set of business rules and further integrated them into said trainable general payment fraud model executable;
subsequently detaching said trainable general payment fraud model executable and for using them on a target application system; and
installing said trainable general payment fraud model executable on other computer systems to control payment fraud evident in the transaction data they process later.

9. The method of claim 8, further comprising:
embedding an incremental learning technology and smart-agent technology able to continually re-train said artificial intelligence classifiers.

10. The method of claim 9, further comprising:
incrementally changing any said initial decision trees by creating new links or updating existing links and weights.

11. The method of claim 10, further comprising:
run-time updating of the weight matrix of any said initial neural networks.

12. The method of claim 11, further comprising:
run-time updating any said initial case-based reasoning logic to update its generic cases or create new ones.

13. The method of claim 12, further comprising:
self-updating said initial population of smart-agents profiles and for creating exceptions to adjust their normal/abnormal thresholds.

14. The method of claim 13, further comprising:
producing an independent and separate vote or fraud judgment from each of said classification algorithm model executable, population of smart agents, and profilers; and
weighting and summing together each said independent and separate vote or fraud judgment; and
outputting a final fraud judgment.
